(19) United States
(12) Patent Application Publication
(10) Pub. No.: US 2010/0237808 A1
(43) Pub. Date: Sep. 23, 2010

(54) EFFICIENT GENERATOR GRID CONNECTION SCHEME POWERING A LOCAL VARIABLE FREQUENCY MOTOR DRIVE

(76) Inventors: Jeong Hyeck Kwon, West Hartford, CT (US); Edward A. Clark, East Longmeadow, MA (US); Giridhari L. Agrawal, Simsbury, CT (US)

Correspondence Address: MCCORMICK, PAULDING & HUBER LLP, CITY PLACE II, 185 ASYLUM STREET, HARTFORD, CT, 06103, US

(21) Appl. No.: 12/726,819

(22) Filed: Mar. 18, 2010

Related U.S. Application Data
(60) Provisional application No. 61/161,199, filed on Mar. 18, 2009.

(51) Int. Cl. H02P 25/30

(52) U.S. Cl. 318/148

(57) ABSTRACT

A system for using a generator to simultaneously power a variable frequency motor drive locally and provide clean power to a grid comprising an electric generator supplying alternating current to a power conversion system. The power conversion system includes a converter changing generator AC output to direct current (DC); a capacitor bank that filters the DC from the converter and outputs a DC bus power; a grid inverter capable of replicating grid power from the DC bus power; and an output filter for supplying power to the power grid. A variable frequency motor drive receives DC bus power from the power conversion system. The variable frequency motor drive may be operatively connected to the power conversion system, or integrated therein.

### CROSS-REFERENCE TO RELATED APPLICATION

This application claims the benefit of U.S. Provisional Application No. 61/161,199, filed Mar. 18, 2009, which is incorporated herein by reference.

### TECHNICAL FIELD OF THE INVENTION

The present invention generally relates to the conversion of mechanical energy to useful local electric power and clean electricity to be fed back to a utility power grid. More specifically, the present invention relates to a method and apparatus for powering Variable Frequency Drive loads locally prior to or contemporaneously with converting the power for utility and grid use.

### BACKGROUND OF THE INVENTION

Power quality standards have raised need, expectations and requirements for generator output and performance. Generator systems are commonly used to provide power to a utility grid, which then supplies power to local loads. Increased demand for power efficiency has led to use of more variable speed motors to improve generator performance. This has led to increased adoption of variable frequency motor drives in generator systems. While improved power factor of such variable frequency motor drives is beneficial, harmonic distortion and other feedback effects associated with such drives from non-linear loads (such as pumps, blowers, and fans) are detrimental to power quality and efficiency. Traditionally, even when non-linear loads are local to a generator system, they have been run off grid power and thus they directly affect grid power quality. Accordingly, a system that minimizes the effects of non-linear loads on the grid is desirable.

A conventional configuration of a generator grid connection scheme is illustrated in the block diagram of FIG. 1. As shown, output from a generator 1 is rectified to direct current (DC) power by a 3-phase to DC converter 2. The converter 2 typically converts alternating current (AC) output from the generator 1 to a DC level, which is filtered by a capacitor bank 3 that outputs a DC bus power to a grid inverter 4. The output for the grid inverter is passed through an output filter 5 to provide clean power suitable for feeding back to a utility power grid. Traditionally, all generator power is converted to AC for the utility power grid.

In the conventional scheme, all generator output is delivered to the grid and grid power is supplied to local loads. For example, in FIG. 1, power from the grid is supplied to a variable frequency drive 6 and an associated motor 7. In such a system, while the generator power is converted to AC for the power grid, the power must be converted back to DC for use by the variable frequency drive 6.

Microprocessor-based grid connection devices using Pulse Width Modulation are becoming very common. These devices control the switching of an inverter to replicate grid power from sources that cannot connect directly to the grid. With Pulse Width Modulation, the power is converted to DC and then the DC power is fed to an inverter where it is switched on and off to replicate the grid power. The power from devices such as a wind turbine that varies with the power source (i.e. wind speed), can thus supply power at a constant frequency and voltage. Also power from devices such as high-speed generators can be converted to a power which is suitable for use on the utility grid.

Inverters used in the Pulse Width Modulation process utilize high-frequency and high-power capable switching components. These components are expensive and represent a significant cost increase for the design of generator systems. For an optimal system design, the power level and quantity of such switching components must be minimized. Accordingly, an alternate for conventional Pulse Width Modulation designs is desirable.

Cost reduction made possible by the invention is vital to enabling the adoption of new technologies and getting them to market. In the case of very high speed generators, the output electronics can be of size equal to or even greater than the generator itself. Size reduction facilitated by the invention is integral in minimizing the impact of installing a new system and getting new systems to fit into an available footprint without compromising performance or efficiency.

The result of the present invention is a generator system that takes advantage of technological advances in a way that substantially reduces system size and cost and represents a significant advance in the state of the art.

### SUMMARY OF THE INVENTION

The present invention is directed to a method and apparatus that uses a direct current (DC) bus to locally power variable frequency motor drive loads before or contemporaneously with conditioning the power and matching it to a utility grid for external connection. In accordance with the present invention, the effect that locally driven components have on grid power quality is reduced.

In one aspect of the present invention, a power generating system includes an electric generator providing alternating current (AC), a power conversion system, and a variable frequency motor drive. The power conversion system comprises a converter changing generator AC output to direct current (DC); a capacitor bank that filters the DC from the converter and outputs a DC bus power; a grid inverter capable of replicating grid power from the DC bus power; and an output filter for supplying clean power suitable to be fed to a power grid. The variable frequency motor drive receives DC bus power from the power conversion system. The variable frequency motor drive may be integrated into the power conversion system or independent from, but operatively connected to, the power conversion system. Each variable frequency motor drive includes an associated motor.

The variable frequency drive (VFD) utilized for the present invention readily accepts DC power for operation. The input power supply components in a traditional VFD, which must convert an AC input to DC power for internal use are unnecessary and can be removed in the power conversion system. This reduces the number of components for the system, thus reducing cost while increasing reliability.

Additionally, by siphoning off DC power in the power conversion system and powering local components of a generating system (e.g., motor, pump, blower, fan), such local components can be independent of the grid, even though power is provided to components of the power conversion system and the power grid from the same power source.

Utilizing DC power during the conversion process to power local components (e.g. motor, pump, blower, fan) and associated support systems places harmonic distortion and other electrical interference produced by such loads internal to the power conversion system. Thus such electrical noise can more easily be filtered and eliminated as it passes through the output filter. Normally, harmonic distortion and interference from a VFD is transmitted directly to the grid and effects power quality for a large number of customers. The present invention dramatically reduces the effects that non-linear motor drive loads and other loads have on the grid power quality.

The overall system efficiency of the present invention is improved over current technology. Power conversion has losses. Traditionally, all generator power is converted to AC for the power grid and then converted back to DC for use in a VFD running off the grid (as illustrated in FIG. 1). By utilizing DC bus power and removing these conversion steps, in accordance with the present invention, the electrical losses and associated heat produced can be eliminated.

In addition, taking power for local loads by way of the power conversion system of the present invention prior to or contemporaneously with replicating grid power for external supply minimizes the size and complexity or the grid connection circuit which, in turn, greatly reduces the overall size and cost of the system.

These and other features of the present invention are described with reference to the drawings of preferred embodiments of a system for converting mechanical energy to local power and a method for such power conversion. The illustrated embodiments of the system in accordance with the present invention are intended to illustrate, but not limit, the invention.

### BRIEF DESCRIPTION OF THE DRAWINGS

FIG. 1 is a block diagram representing a conventionally configured power conversion system configuration where a Variable Frequency Drive in the system is not integrated and nonlinear loads are powered directly from a power grid.

FIG. 2 is a block diagram representing a power conversion system configuration in accordance with the present invention having an integrated Variable Frequency Drive and which outputs motor power locally and provides clean power to a power grid.

FIG. 3 is a block diagram representing an alternate power conversion system configuration in accordance with the present invention which outputs DC power locally for separate Variable Frequency Drives and provides clean power to a power grid.

### DESCRIPTION OF PREFERRED EMBODIMENTS

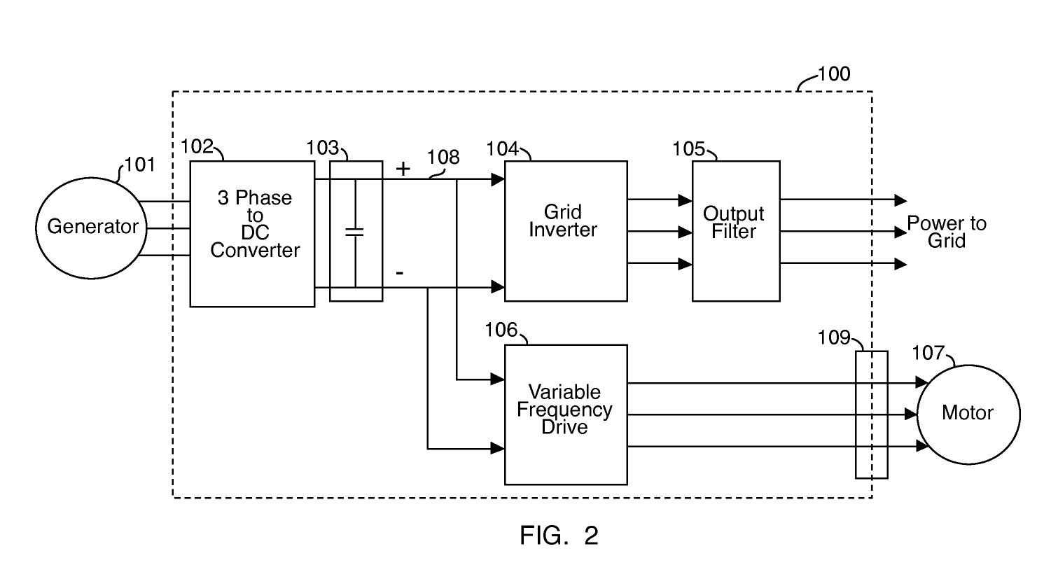

The present invention is directed to a method and apparatus that uses a direct current bus to locally power variable frequency motor drive loads before or contemporaneously with conditioning the power and matching it to a utility power grid for external connection. FIG. 2 illustrates a block diagram of a grid power conversion system 100 configured as a preferred embodiment of the present invention. As shown, output from a generator 101 is rectified to a DC level in the system 100 by a 3-phase to DC Converter 102. The generator 101 is preferably an electric generator providing AC output and voltage at varying levels and varying frequencies. The converter 102 converts the generator AC output to a DC level, which is further filtered by a capacitor bank 103 that outputs a DC bus power. This DC bus power is split at node 108 to supply power to both an integrated variable frequency drive (VFD) 106 and a grid inverter 104.

The grid inverter 104 uses voltage and current sensors to observe the grid power (including voltage level and phase) and switches the DC bus power to create a pulse width modulated signal that replicates and matches the sensed grid power. The output from the grid inverter 104 is passed through an output filter 105 to provide clean power suitable for feeding back to the utility power grid. As with conventional grid connections from a generator system, the generator power from the system 100 is converted to AC for the power grid. The output from the grid inverter 104 is independent from any power that has been directed to the VFD 106. The innovation of the present invention is seen in powering the integrated VFD 106 from the DC bus 108 and realizing the benefits described herein.

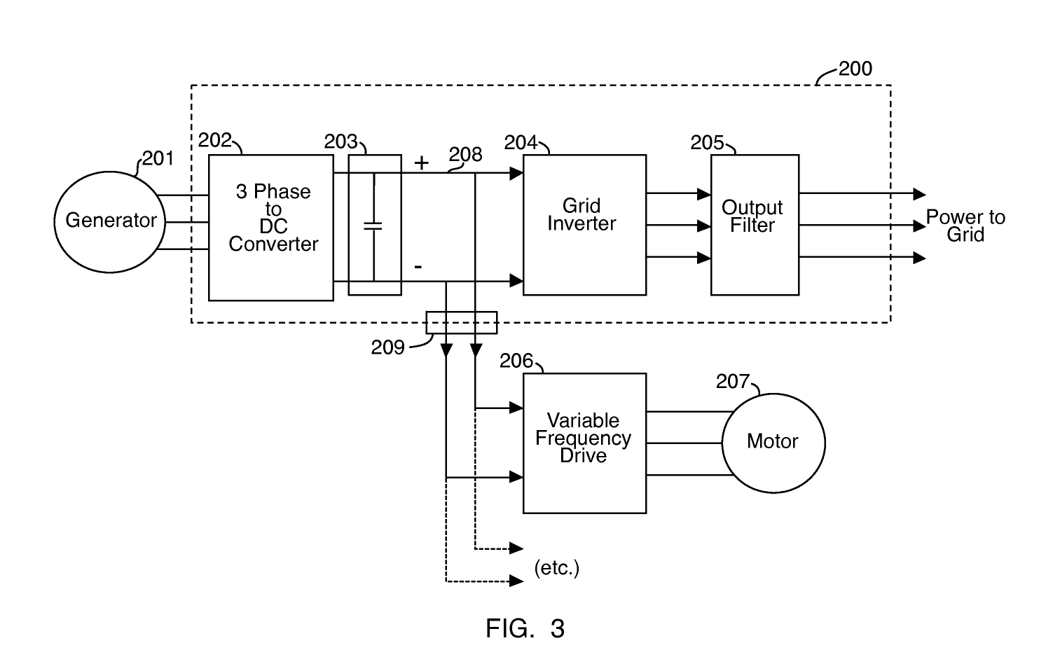

As noted, a portion of the DC bus power 108 is supplied to the VFD 106 and the remaining DC bus power is converted for the grid and utility power usage. As shown in FIG. 2, a portion of the DC bus power is supplied to the VFD 106 prior to converting the power for grid usage. The VFD 106 is integrated into the power conversion system 100 and power from the VFD 106 is supplied through a three-phase output 109 to a motor 107 associated with the VFD 106. As described below with respect to FIG. 3, one or more VFDs can be independent from a grid power conversion system 200 and still be locally powered by a load provided from the system before or contemporaneously with the output power is conditioned for feedback to a utility grid.

The VFD output 109 in the FIG. 2 configuration is also available to operate other local loads. An example might be a condensate pump, a blower, or a cooling fan driven by the VFD 106 for use in the generation system. An integrated VFD represents a savings in size and packaging. In addition, such a system configuration can simplify operation by having electronics integrated in a single package. This also can simplify other aspects of the system, such as facilitating a cooling scheme, or allowing for harmonic distortion, electrical noise and other interference to be more easily filtered or otherwise accounted for within the system. The illustrated configuration is limited in that the three-phase output 109 can only power one device. The system 100 could be designed to accommodate additional devices, but the output must be properly allocated. Thus, the system designer must know and plan each local load in advance so particular VFD or VFDs can be accounted for and integrated during manufacturing.

FIG. 3 illustrates a block diagram of a grid power conversion system 200 configured as an alternative embodiment of the present invention. In general, the system 200 illustrated in FIG. 3 is capable of outputting DC power locally to independent VFDs 206. Similar to the system 100 illustrated in FIG. 2, the output from a generator 201 is rectified to a DC level by a 3-phase to DC converter 202. The rectified DC power is then filtered by a capacitor bank 203. The filtered DC bus power can be apportioned at node 208 to supply one or more VFDs 206 and a grid inverter 204 in the system 200.

As shown in FIG. 3, the DC bus power can be provided through an output 209 to supply one or more VFDs 206 operatively connected to the system 200. The power provided to each VFD 206 can be used to locally operate an associated motor 207 for local loads such as pumps, blowers and fans. In addition, the DC bus power is internally supplied to the grid inverter 204 which uses voltage and current sensors to sense the voltage level and phase of the grid power, and then uses pulse width modulation to switch the DC bus power to replicate and match the sensed grid power. The output from the grid inverter 204 is passed through an output filter 205 to provide clean power suitable for feeding back to the utility power grid.

Though only one independent VFD 206 is illustrated in FIG. 3, the system 200 can be used to supply local power to multiple VFDs, as indicated by the broken arrows. Each VFD can be associated with a different motor. For instance a generator system may commonly use a condensate pump and cooling fans, any or all of which could be driven by separate VFDs. The number of such loads depends on the system design and will vary greatly depending on the arrangement. The scope of the present invention is not specific to a generator system and is not limited to a particular type or number of loads.

Providing a DC power output connection 209 in the system 200 allows this embodiment of a system configured under the current invention to be more scalable. VFDs and associated local devices can be added or removed as necessary. Any VFD used under the current invention will be modified as described herein to take full advantage of the benefits of the invention.

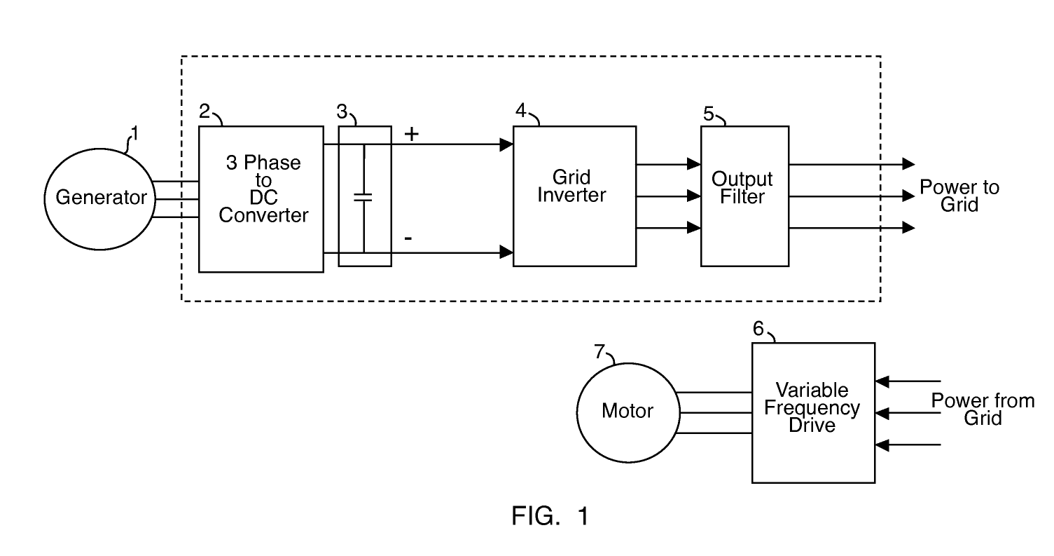

The system of the present invention improves generator output power quality by removing non-linear loads (e.g., VFDs) from the grid. Traditionally, as shown in FIG. 1, all generator output is delivered to the grid and then local loads draw power supplied from the utility grid power. This means the net output power from the total system includes harmonics and electrical interference from the local VFD. The present invention places all locally generated noise on the DC bus before the AC power conversion and before power for the grid is supplied through the output filter. Thus, the system of the present invention is better able to remove the unwanted effects of non-linear loads.

Additionally, the present system, as configured in either FIG. 2 or FIG. 3, negates the need for a passive or active rectifier module, a filter, or a choke, at the input of the variable frequency motor drive. A conventional VFD utilizes a filter, or a choke, at the input to smooth out the incoming AC signal and reduce the harmonics and electrical interference the drive feeds back to the grid. These functions are performed by the grid connect system in the case of the present invention. A traditional VFD uses a passive or active rectifier module to convert AC at the input to DC for conversion to the drives output voltage and frequency. In the present invention, the VFD is fed with DC so the rectifier module at the VFD input is not needed.

Similarly, a system configured in accordance with the present invention negates the need for a charging circuit or a dynamic break for the variable frequency motor drive. Energy is stored on the DC bus so no charging system is required. Likewise, energy can be fed back to the DC bus in the case of dynamic breaking so no break resistor is needed. In this case, the energy is then converted to useful grid power instead of being wasted as heat by a break resistor.

The components used in a conventionally configured system as diagramed in FIG. 1 and a conventional VFD as described above, which are removed for the current invention, have losses associated with them. Removing these components and eliminating those losses increases system efficiency. In addition, powering local loads before converting DC to grid power reduces the power that is converted. This means that fewer losses occur in the Grid Inverter. In summary, each stage of the energy conversion process has losses, using the DC bus to directly power both VFD loads (be it integrated (FIG. 2) or independent (FIG. 3)) and a grid inverter, rather than converting all power to grid power prior to use, represents a net efficiency gain for a grid power conversion system.

The grid inverter used in the present invention is preferably rated at a substantially lower power level than an equivalent system that drives local loads using grid power. This means that the grid inverter of the system can use smaller components. Since the grid inverter is typically the most costly portion of such a power conversion system, reducing the size of its components can represent a significant cost savings in design and operating such a system. Moreover, the entire system in accordance with the present invention, including the variable frequency drive, can represent a sizable reduction in system weight and volume and component weight and volume.

The use of fewer and smaller components, along with the net efficiency gains described above, represents a considerable reduction in the heat load of the system. This heat reduction correlates to improved component life and significantly improved system reliability. Additionally, the reduction in heat load of the system reduces the size of any auxiliary cooling system that may be needed to cool the system. In general, the present invention represents a substantial increase in power quality and efficiency.

The foregoing description of the present invention has been presented for the purpose of illustration and description. It is not intended to be exhaustive as to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular uses contemplated. It is intended that the scope of the present invention be defined by the claims appended hereto.

What is claimed is:

1. A power generating system for simultaneously powering a variable frequency motor drive locally and providing clean power to a power grid, said system comprising:
an electric generator providing alternating current (AC);
a power conversion system receiving AC output from the generator, said power conversion system comprising:
a converter changing generator AC output to direct current (DC);
a capacitor bank that filters the DC from the converter and outputs a DC bus power;
a grid inverter capable of replicating grid power from the DC bus power; and
an output filter for supplying power to the power grid; and
a variable frequency motor drive receiving DC bus power from the power conversion system;
wherein the DC bus power outputted by the capacitor bank is split and provided to both the grid inverter and the variable frequency motor drive.

2. The power generating system according to claim 1, wherein the variable frequency motor drive is integrated into the power conversion system.

3. The power generating system according to claim 2, further comprising a motor operatively associated with the variable frequency motor drive.

4. The power generating system according to claim 3, wherein the power conversion system further comprises a three-phase output, whereby power from the variable frequency motor drive is supplied through said outlet to the motor.

5. The power generating system according to claim 1, wherein the power conversion system further comprises a DC power output connection, and wherein the variable frequency motor drive is operatively connected to the power conversion system by means of said DC power output connection.

6. The power generating system according to claim 5, further comprising a motor operatively associated with the variable frequency motor drive.

7. The power generating system according to claim 5, further comprising a plurality of variable frequency motor drives operatively connected to the power conversion system by means of the DC power output connection.

8. The power generating system according to claim 7, further comprising a motor operatively associated with each of the plurality of variable frequency motor drives.

9. The power generating system according to claim 1, wherein the converter is a three-phase to DC converter.

10. The power generating system according to claim 1, wherein the grid inverter creates a pulse width modulated signal that replicates grid power.

11. The power generating system according to claim 10, wherein the power conversion system further comprises at least one sensor operatively connected with the grid inverter to sense grid power.

12. The power generating system according to claim 11, wherein the at least one sensor senses voltage level and phase of the grid power.
